(19) United States
(12) Patent Application Publication
(10) Pub. No.: US 2022/0391022 A1
(43) Pub. Date: Dec. 8, 2022

(54) SYSTEM AND METHOD FOR HUMAN-DEVICE RADAR-ENABLED INTERFACE

(71) Applicant: ARRIS ENTERPRISES LLC, Suwanee, GA (US)

(72) Inventor: Yuvaraj Nagarathinam, Bangalore (IN)

(73) Assignee: ARRIS ENTERPRISES LLC, Suwanee, GA (US)

(21) Appl. No.: 17/830,007

(22) Filed: Jun. 1, 2022

(30) Foreign Application Priority Data
Jun. 3, 2021 (IN) 202121024760

(51) Int. Cl. G06F 3/01; G01S 13/00; G01S 7/41; G01S 13/86

(52) U.S. Cl. CPC G06F 3/017; G06F 3/011; G01S 13/003; G01S 7/415; G01S 13/86

(57) ABSTRACT

A system and method providing a radar-based motion-sensing user interface suitable for issuing commands to a device or system as a consequence of the detection of user motion, whole-body gestures and/or hand gestures. The system and method derive a three-dimensional representation of a user within a defined space from two-dimensional data obtained from multiple reflected radar signals. The three-dimensional representation is then processed to recognize a human body, and in particular the movement and/or position of the body and/or body parts and joints. The recognized movement and/or position are then compared to a known list of gestures and movements that are associated with particular device/system commands. If one or more of the recognized movements and/or positions conforms with a command movement/gesture, the associated command is issued to the device or system being controlled.

### CROSS-REFERENCE TO RELATED APPLICATION

This application claims the benefit of Provisional Patent Application No. 202121024760, filed Jun. 3, 2021 with the Office of the Controller General of Patents, Designs and Trade Marks of India, which is incorporated by reference herein in its entirety.

### BACKGROUND OF THE INVENTION

Recent years have seen the expanding use of touchless device interfaces. With the advent of the recent pandemic, the use of touchless interfaces has only accelerated. Such interfaces can be placed into two broad categories: voice-based interfaces and gesture-based interfaces.

The voice-based user interfaces have progressed greatly since the introduction of Apple's Siri in 2010, Amazon's Alexa in 2014, and Google's Assistant in 2016. These voice-based systems, have been integrated into numerous devices (such as mobile phones and televisions) and are also available as stand-alone devices, such as Amazon's Echo and Google's Home. Based strictly upon the rate at which voice-interface devices have sold, it would appear that consumers have had little issue with adopting this technology and utilizing it in their daily interactions with “smart” devices.

The gesture-based device interfaces have not seen the same level of development or adoption. For example, Microsoft's Kinect system was originally marketed as a means of replacing hand-held controllers associated with Xbox gaming system, but apparently failed to find wide adoption by the gaming community and was ultimately removed from being bundled with the Xbox by Microsoft. In addition, Kinect employed a video camera to track user gestures and movements. Video-based systems, although suitable the capture and interpretation of whole-body gestures, are unacceptable to some users as many find the capturing of video to be a threat to their privacy. In addition, video-based systems like Kinect cannot sense body movements as the movements are obscured by loose clothing, such as a robe or sari.

Radar-based systems offer an alternative gesture sensing technology. Google's short-range (approximately 15 cm) radar-based control project, designated Soil, has found some success in the handheld smart device (phones, tablets, etc.) market, as well as the home control market (wall-mounted light and environmental controls). However, short-range radar is not practical for the capturing of whole-body gestures or user hand motions at a distance.

Present user interfaces employing longer-range and wider-field radar as a sensing means fail to adequately provide a system wherein hand gestures can be isolated and detected if the user's hand is not isolated from the user's body. For example, if a user was holding his or her hand in a position such that the hand was located in front of the user's body when viewed from the vantage point of the radar sensor.

Consequently, there exists a need for a system and method supporting a gesture-sensing touch-less interface capable of capturing and interpreting whole-body and/or hand gestures employing a wide-field radar suitable for capturing both body position and gestures, as well as hand positions and gestures at a reasonably long distance from the interface sensor(s). This would maintain the anonymity and privacy of the user or users, and permit the sensing of body motion even if the users' limbs and/or hands were shrouded by a garment. This reasonably long distance would ideally enable the system and method to be serve as a practical user interface for users located throughout a reasonably proportioned residential room.

### BRIEF SUMMARY OF THE INVENTION

A system and method providing a radar-based motion-sensing user interface suitable for issuing commands to a device or system as a consequence of the detection of user motion, whole-body gestures and/or hand gestures. The system and method derive a three-dimensional representation of a user within a defined space from two-dimensional data obtained from multiple reflected radar signals. The three-dimensional representation is then processed to recognize a human body, and in particular the movement and/or position of the body and/or body parts and joints. The recognized movement and/or position are then compared to a known list of gestures and movements that are associated with particular device/system commands. If one or more of the recognized movements and/or positions conforms with a command movement/gesture, the associated command is issued to the device or system being controlled.

### BRIEF DESCRIPTION OF THE DRAWINGS

The aspects, and advantages of the present invention will become better understood with regard to the following description, appended claims, and accompanying drawings in which:

FIG. 1 is a functional block diagram of a system supporting a human-device radar-enabled interface in accordance with an embodiment of the invention.

FIG. 2A depicts an antenna array suitable for use with the system of FIG. 1.

FIG. 2B depicts the integration of the antenna array of FIG. 2A into a television.

FIG. 2C depicts the television of FIG. 2B within a user space.

FIG. 3 is a flow diagram of a first process supported by the system of FIG. 1.

### DETAILED DESCRIPTION

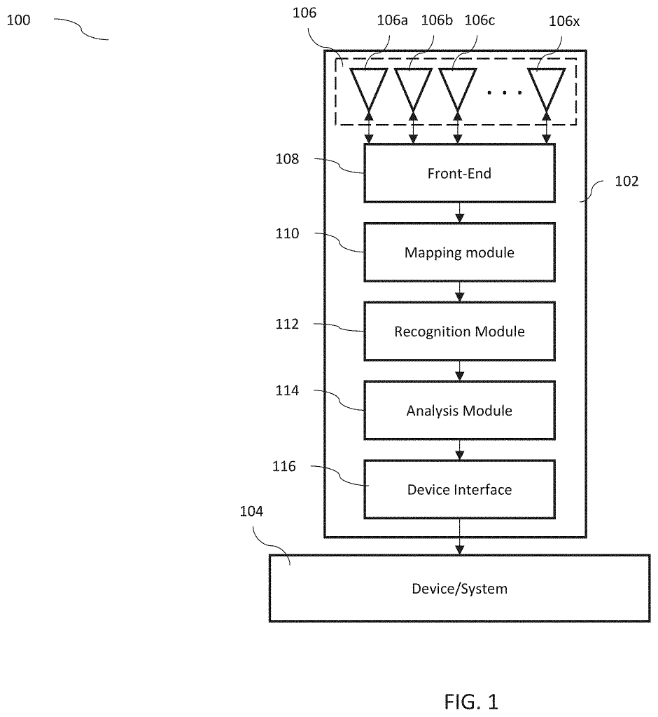

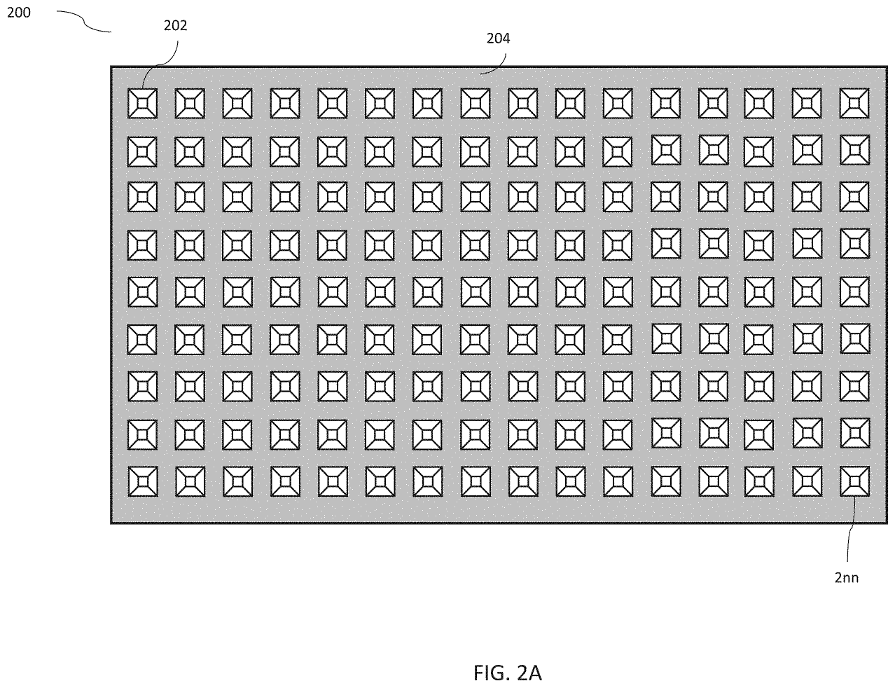

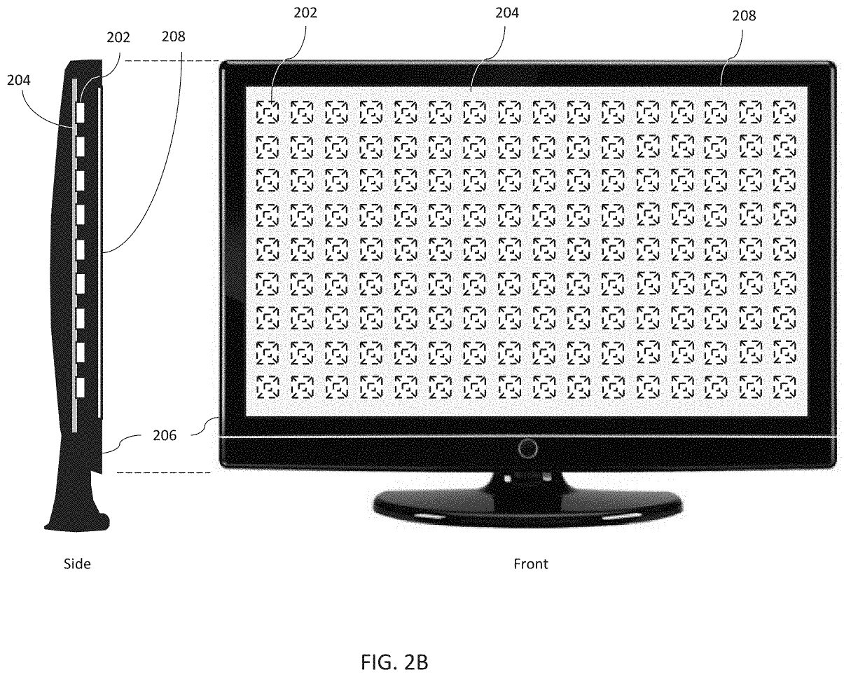

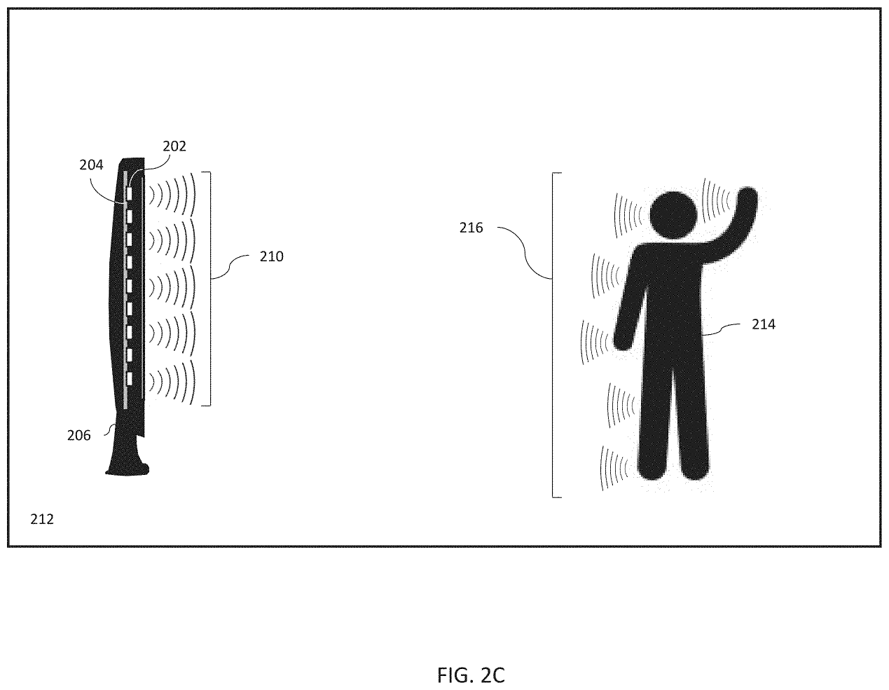

FIG. 1 provides a functional block diagram of system 100 which supports a radar-based user interface suitable for the control of various electronic devices. As shown, the system includes human interface 102 and device/system 104. Radar transceiver 106 is shown to be integrated within human interface 102. This transceiver is comprised of multiple antenna elements (106a-106x), each situated in at specific location within an antenna array. One such array (200) is depicted in FIG. 2A. As shown, a 16×9 matrix of 144 individual transceivers (202-2nn) are mounted upon substrate 204 in a rectangular pattern. This geometric arrangement permits the collection of multiple reflected radar images, wherein each reflected image is representative of a “view” of the objects painted by the transceiver matrix.

FIG. 2B provides a partial cutaway front and side view of television 206 into which substrate 204 and its associated antenna matrix have been integrated. As shown, the substrate/antennae are positioned behind display screen 208.

Front-end 108 controls radar transceiver 106, directing the generation of radar signal transmissions, as well as the reception of reflected radar signals. The particular radar modulation and generation employed by the transceiver matrix can be chosen based upon the area or room in which the system will be deployed, as well as the type of command movements and/or gesturers that a user or users will be making. For example, the radar signal can be generated to maximize signal strength so as to provide improved coverage across a large area. Such signal maximization could be achieved by employing an ultrawide band (“UWB”) radar source. The transmitted radar signal can be either a standard scanned beam radar, a synthetic-aperture radar, an inverse synthetic-aperture-radar, or any other reasonable methodology of radar signal generation suitable for the detection of multiple transmission for the collecting of multiple, spatially-disparate object images from a static antenna array. The wavelength of radar signals would ideally be in the millimeter microwave (“mmMw”) range and can either be produced in a continuous wave (“CW”) or intermittently as chirps or bursts.

Under the control of front-end 108, transceiver 106 generates multiple radar signals (210, see FIG. 2C) which are projected into user space 212 (an area where a user (214) issuing commands would be positioned). These multiple radar transmissions may be sent out in succession, or concurrently, as long as each was transmitted from a different point of origin within transceiver 106. This point of origin may be physical (a particular antenna) or virtual (a construct of the interaction of multiple radar signals). Front end 108 differentiates, demodulates, and/or down-converts the received reflected radar signals (216) and compiles information indicative of multiple two-dimensional images of the object or objects from which the radar signals were reflected back to transceiver 106. This two-dimensional data can be collected over a given interval so as to provide a series of radar snap-shots of the user space. This is critical in sensing motion and direction of users within the space. Such front-ends are well-known in the art, and the particulars of the radar signal processing will not be discussed in detail. The two-dimensional data is then provided to mapping module 110.

Mapping module 110, based at least in part upon the particular location of the origin point of the radar signal associated with each of the two-dimensional reflections associated with each snap shot, synthesizes the two-dimensional data into three-dimensional representations. This two-dimensional to three-dimensional synthesis is well-known in the art and will not be discussed in detail here. The three-dimensional data is then provided to recognition module 112.

Recognition module 112, which includes one or more processors and associated memory or memories, receives the three-dimensional data. Then, utilizing either preprogrammed templates or adaptive artificial intelligence algorithms, recognizes and isolates human images (body, head, extremities, hands, feet, fingers, joints, inflection points, inflection angles, etc.). Data indicative of these recognized human images is then sent to analysis module which filters the images to detect positions, gestures or motions indicative of predetermined device/system commands. The analysis module may be programmed to recognize particular static positions of a user's fingers or body (an OK hand signal, a salute, fingers extended to form a V, etc.), the performance of a particular motion (jumping in the air, waving a hand, walking, etc.) or a change in the overall position or posture of a user's body (turning to the left or right, coming to attention, slouching, etc.).

If one or more detected user gestures or actions is recognized as corresponding to a device/system command, analysis module 114 activates device interface 116 to issue a command to the appropriate device or system. The issuance of this command can be via a tethered connection, such as a wired/optical fiber network or internal bus (in systems where human interface 102 is integrated with the device being controlled, such as a television, a set-top box, or other media gateway appliance), or by wireless means, such as radio, infrared, ultrasonic, sonic or optical means. The receiving device/system would then execute the operation or operations associated with the command.

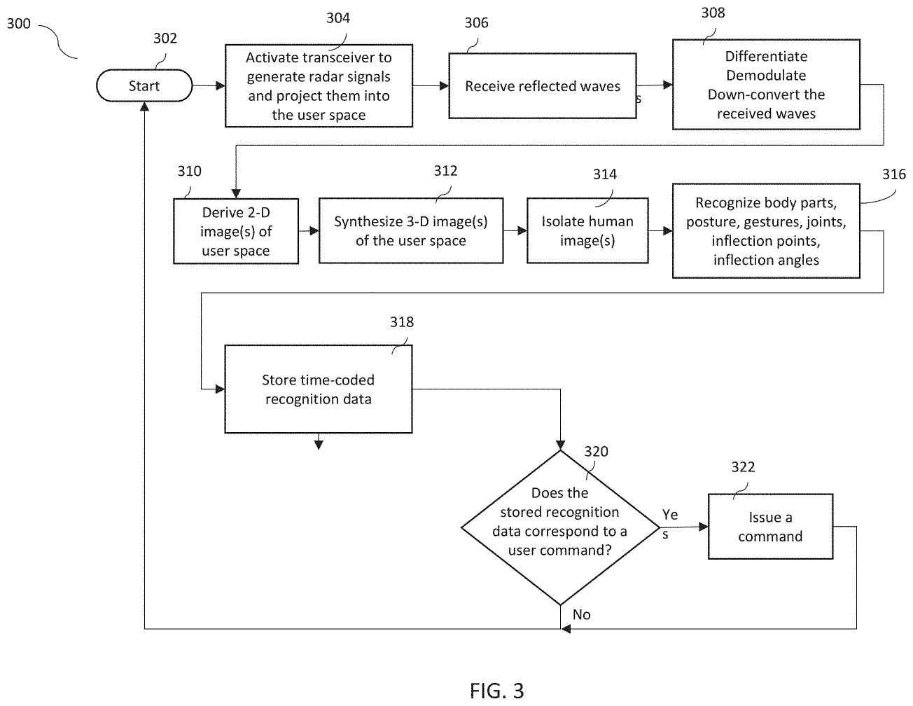

FIG. 3 provides a flow diagram of a preferred process (300) utilizing the system of FIG. 1. The process begins with the activation of the radar transceiver and the projection of radar waves into the user space (steps 302 and 304). The reflected waves are then received by the transceiver (step 306). In step 308 the received signals are differentiated, demodulated and/or down-converted. Two-dimensional images of the user space are then derived (step 310) and utilized to derive one or more three-dimensional images of the user space (step 312). Human images are then isolated within the three-dimensional image(s) (step 314) and body parts, posture, gestures, joints, inflection points and inflection angles are recognized (step 316). If multiple three-dimensional images representative of a snap-shots of the user space over a given interval of time were derived, the recognition data associated with each such image is stored in a time-coded manner (step 318).

Next, in step 320, the system tests to determine if stored data is indicative of a motion, action, gesture or position associated with a user command. If so, the process continues with step 322 and a command is issued to the appropriate device or system. If step 320 results in a negative outcome, the process reverts to step 302 and begins anew.

Although the invention herein has been described with reference to particular embodiments, it is to be understood that these embodiments are merely illustrative of the principles and applications of the present invention. Other embodiments and variations could be implemented without departing from the spirit and scope of the present invention as defined by the appended claims. In addition, it will be understood that the various connections depicted as wired in the above embodiments could also be supported by wireless connections without departing from the scope of the invention. The processes described herein could be performed by a single or multiple multi-processor system, co-located with the user and/or device(s) being controlled, or remotely based in whole or in part. The memory supporting the storage of the data can be a disk, a solid-state drive, cloud-based storage (in whole or in part), or any other means with sufficient capacity. Similarly, any number of various video-capable devices could serve as a platform for the transceivers. The transceivers could also be integrated into other consumer electronic devices (sound bars, speakers, set-top boxes, computer monitors, etc.), mounted upon a stand-alone assembly, or built into or behind one or more walls forming the user space. The disclosed invention could also be utilized to control lighting or environmental systems within a given space. The application of this invention is also not limited to rooms within residential dwellings. The technology could be utilized to sense command motions or gestures within any reasonably sized room or enclosure, including motor vehicles. It could also be utilized in outdoor settings.

1. A system for generating control commands comprising:
a plurality of spatially-disparate radar sources;
a plurality of spatially-disparate radar receivers;
at least one memory storing information indicative of at least one three-dimensional positioning of human body features, wherein the three-dimensional positioning corresponds to at least one control command; and
a controller, adapted to:
instruct the plurality of spatially-disparate radar sources to each generate and project at least one radar signal into a defined space;
receive, via the plurality of spatially-disparate radar receivers, reflections of the generated and projected radar signals;
derive a at least one two-dimensional representation of the defined space from each of the received reflections;
construct at least one three-dimensional representation of the defined space from the two-dimensional representations of the defined space;
recognize at least one feature associated with a human body within the constructed three-dimensional representation;
compare the at least one recognized feature to the information stored in the at least one memory in order to determine if the recognized features correspond to the at least one three-dimensional positioning of human body features corresponding to at least one control command; and
generate the corresponding control command.

2. The system of claim 1 wherein the plurality of spatially-disparate radar sources comprise at least one of the following:
a plurality of physical sources;
a plurality of virtual sources;
a plurality of burst sources;
a plurality of chirp sources;
a plurality of continuous wave sources;
a plurality of scanned beam sources;
at least one synthetic-aperture source;
at least one inverse synthetic-aperture source;
at least one burst source;
at least one chirp source;
at least one millimeter microwave source; and
at least one static array of sources.

3. The system of claim 1 wherein the defined space comprises at least one of the following:
a room in a residential dwelling;
an auditorium;
the interior of a motor vehicle; and
an outdoor space.

4. The system of claim 1 wherein the at least one of the plurality of spatially-disparate radar sources or the plurality of spatially-disparate radar receivers are integrated into at least one of the following:
a television;
a computer monitor;
a media gateway appliance;
a set-top box;
an audio speaker system;
a wall at least partially defining the defined space;
a stand-alone apparatus;
an automobile dashboard; and
an automobile headliner; and
an automobile door panel.

5. The system of claim 1 wherein the at least one memory comprises at least one of the following:
a disc drive;
a solid-state drive; and
a cloud-based storage system.

6. The system of claim 1 wherein the at least one three-dimensional positioning of human body features corresponding to at least one control command comprise at least one of the following:
a hand gesture;
a hand motion;
a hand position;
a posture;
movement of an extremity;
position of an extremity;
movement of a head; and
position of a head.

7. The system of claim 1 wherein the at least one control command is adapted to control at least one of the following:
a television;
a computer;
an audio system;
an automotive system;
a video system;
a media gateway appliance;
a set-top box;
a lighting system; and
an environmental system.

8. The system of claim 1 wherein the recognition of at least one feature associated with a human body within the constructed three-dimensional representation is based, at least in part, upon at least one of the following:
a stored template; and
an adaptive algorithm

9. The system of claim 1 wherein the at least one three-dimensional representation of the defined space comprises a plurality of three-dimensional representations indicative of the state of the defined space over a finite period.

10. The system of claim 9 wherein the recognition of at least one feature associated with a human body within the plurality of three-dimensional representations comprises the recognition of at least one particular motion.

11. A method for generating control commands; in a system comprising:
a plurality of spatially-disparate radar sources;
a plurality of spatially-disparate radar receivers; and
at least one memory storing information indicative of at least one three-dimensional positioning of human body features, wherein the three-dimensional positioning corresponds to at least one control command;
the method comprising the steps of:
instructing the plurality of spatially-disparate radar sources to each generate and project at least one radar signal into a defined space;
receiving, via the plurality of spatially-disparate radar receivers, reflections of the generated and projected radar signals;
deriving a at least one two-dimensional representation of the defined space from each of the received reflections;
constructing at least one three-dimensional representation of the defined space from the two-dimensional representations of the defined space;
recognizing at least one feature associated with a human body within the constructed three-dimensional representation;
comparing the at least one recognized feature to the information stored in the at least one memory in order to determine if the recognized features correspond to the at least one three-dimensional positioning of human body features corresponding to at least one control command; and
generating the corresponding control command.

12. The method of claim 11 wherein the plurality of spatially-disparate radar sources comprise at least one of the following:
a plurality of physical sources;
a plurality of virtual sources;
a plurality of burst sources;
a plurality of chirp sources;
a plurality of continuous wave sources;
a plurality of scanned beam sources;
at least one synthetic-aperture source;
at least one inverse synthetic-aperture source;
at least one burst source;
at least one chirp source;
at least one millimeter microwave source; and
at least one static array of sources.

13. The method of claim 11 wherein the defined space comprises at least one of the following:
a room in a residential dwelling;
an auditorium;
the interior of a motor vehicle; and
an outdoor space.

14. The method of claim 11 wherein the at least one of the plurality of spatially-disparate radar sources or the plurality of spatially-disparate radar receivers are integrated into at least one of the following:
a television;
a computer monitor;
a media gateway appliance;
a set-top box;
an audio speaker system;
a wall at least partially defining the defined space;
a stand-alone apparatus;
an automobile dashboard; and
an automobile headliner; and
an automobile door panel.

15. The method of claim 11 wherein the at least one memory comprises at least one of the following:
a disc drive;
a solid-state drive; and
a cloud-based storage system.

16. The method of claim 11 wherein the at least one three-dimensional positioning of human body features corresponding to at least one control command comprise at least one of the following:
a hand gesture;
a hand motion;
a hand position;
a posture;
movement of an extremity;
position of an extremity;
movement of a head; and
position of a head.

17. The method of claim 11 wherein the at least one control command is adapted to control at least one of the following:
a television;
a computer;
an audio system;
an automotive system;
a video system;
a media gateway appliance;
a set-top box;
a lighting system; and
an environmental system.

18. The method of claim 11 wherein the recognition of at least one feature associated with a human body within the constructed three-dimensional representation is based, at least in part, upon at least one of the following:
a stored template; and
an adaptive algorithm

19. The method of claim 11 wherein the at least one three-dimensional representation of the defined space comprises a plurality of three-dimensional representations indicative of the state of the defined space over a finite period.

20. The method of claim 19 wherein the recognition of at least one feature associated with a human body within the plurality of three-dimensional representations comprises the recognition of at least one particular motion.
